(19) United States
(12) Patent Application Publication
(10) Pub. No.: US 2021/0406435 A1
(43) Pub. Date: Dec. 30, 2021

(54) SYSTEM, METHOD, AND COMPUTER-ACCESSIBLE MEDIUM FOR ABSORPTION BASED LOGIC LOCKING

(71) Applicant: University of Florida Research Foundation, Incorporated, Gainesville, FL (US)

(72) Inventors: Yier Jin, Gainesville, FL (US); Kaveh Shamsi, Gainesville, FL (US)

(21) Appl. No.: 17/357,415

(22) Filed: Jun. 24, 2021

Related U.S. Application Data
(60) Provisional application No. 63/044,708, filed on Jun. 26, 2020.

(51) Int. Cl. G06F 30/327

(52) U.S. Cl. CPC G06F 30/327; H03K 19/20

(57) ABSTRACT

Embodiments provide for absorption-based logic locking. In example embodiments, a method includes receiving a point-function associated with Register Transfer Level (RTL) source code for an integrated circuit. The method further includes mapping data associated with the point-function to a first portion of a row-column-activated look-up-table (RCA-LUT). The method further includes deactivating a second portion of the RCA-LUT by setting bits of the second portion of the RCA-LUT to zero. The method further includes replacing a portion of comparator logic for the integrated circuit with the RCA-LUT.

### CROSS-REFERENCE TO RELATED APPLICATIONS

The present application claims priority to U.S. Provisional Application Ser. No. 63/044,708, titled “SYSTEM, METHOD, AND COMPUTER-ACCESSIBLE MEDIUM FOR ABSORPTION BASED LOGIC LOCKING,” filed Jun. 26, 2020, the contents of which are incorporated herein by reference in their entirety.

### TECHNICAL FIELD

The present application relates to the technical field of integrated circuits. In particular, the invention relates to absorption-based logic locking for an integrated circuit.

### BACKGROUND

Logic locking is a technique for hiding the design of an integrated circuit from untrusted foundries. Logic locking generally involves transforming a design of an integrated circuit into a semi-programmable design that employs an unlocking step before a correct operation. However, conventional logic locking techniques are susceptible to being broken under various threat models due to, for example, a lack of formal definitions of security for conventional logic locking techniques.

### BRIEF DESCRIPTION OF THE DRAWINGS

Reference will now be made to the accompanying drawings, which are not necessarily drawn to scale, and wherein:

FIG. 1 illustrates an algorithm that provides a correct key, according to various embodiments of the present disclosure;

FIG. 2 illustrates a system associated with an AntiSAT point-function EFS scheme, according to various embodiments of the present disclosure;

FIG. 3 illustrates a system associated with a SFLL point-function EFS scheme, according to various embodiments of the present disclosure;

FIG. 4 illustrates a system associated with an AND-tree cone, according to various embodiments of the present disclosure;

FIG. 5 illustrates an algorithm related to outside-of-skewed-cone querying, according to various embodiments of the present disclosure;

FIG. 6 illustrates a system where skewed cones are inserted into a larger circuit, according to various embodiments of the present disclosure;

FIG. 7 illustrates runtime of outside cone querying for circuits, according to various embodiments of the present disclosure;

FIG. 8 illustrates a comparison on a benchmark circuit, according to various embodiments of the present disclosure;

FIGS. 9A and 9B illustrate example combinational gate-level implementations of a row-column-activated look-up-table (RCA-LUT), according to various embodiments of the present disclosure;

FIG. 10 illustrates a transistor-level CAM-based implementation of an RCA-LUT circuit, according to various embodiments of the present disclosure;

FIG. 11 illustrates an RT-level flattened design, according to various embodiments of the present disclosure;

FIG. 12 illustrates a system associated with a comparison statement and an RCA-LUT, according to various embodiments of the present disclosure;

FIG. 13 provides a method that facilitates absorption-based logic locking for an integrated circuit, according to various embodiments of the present disclosure; and

FIG. 14 provides another method that facilitates absorption-based logic locking for an integrated circuit, according to various embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

The high costs of maintaining semiconductor nanofabrication in the sub-100 nano-meter (nm) regime has resulted in a separation of design and fabrication over the years. With more and more companies from various sectors investing in application-specific integrated circuits (ASICs), fabless manufacturing in which designers outsource fabrication to consolidated foundries has been on the rise. However, an untrusted foundry in such a setting raises several security and privacy concerns including, for example, reverse engineering for intellectual property (IP) theft, overproduction, malicious modification of the design of integrated circuits (ICs). In addition to untrusted foundries, end-user microscopy-based reverse-engineering of fabricated integrated circuits can also result in security and privacy concerns.

Various techniques exist for hiding the design of an integrated circuit from untrusted foundries or end-users. For example, integrated circuit camouflaging can be employed to disperse ambiguous-under-microscopy nanostructures throughout the layout of an integrated circuit to, for example, hinder end-user reverse-engineering. However, integrated circuit camouflaging provides no protection against foundries. In another example, split-manufacturing can be employed to the design of an integrated circuit (e.g., divided by metal layer) and fabricate a less costly portion of the integrated circuit in a lower-end trusted foundry. In yet another example, logic locking can be employed in which programmable elements (e.g., one-time programmable ambiguous-under-microscopy elements) are added to the integrated circuit to provide a post-fabrication configuration with a secret bit-string (e.g., a secret key).

Logic locking can provide protection against both foundry and end-users without requiring a trusted foundry. However, with logic locking, it is difficult to secure against attacks with low overhead, as programmable elements employ programming structures that leak the location of ambiguity to the attacker and prevent flooding of the empty spaces in the integrated circuit layout with programmable elements. Integrated circuit camouflaging, split-manufacturing and logic locking can be modeled as transforming a Boolean circuit (or a sequential circuit) to an augmented or locked Boolean circuit with added hidden or key variables. Security under this model relies on the threat model and the definition of security. Threat models may include, for example, oracle-guided (OG) models (e.g., when the attacker has access to a black-box implementation of the original integrated circuit), sequential-oracle-guided (SOG) models (e.g., where the oracle has inaccessible state-elements), oracle-less (OL) models (e.g., where the attacker has access only to the ambiguous design), and the like. Notions of security (e.g., functional-secrecy) can be categorized as exact-functional-secrecy (EFS) (e.g., where the attacker is barred only from perfect learning of the functionality of the original integrated circuit) and approximation-functional-secrecy (AFS) (e.g., where the attacker cannot approximate the original integrated circuit with high accuracy).

The strongest oracle-guided attacks on logic locking are satisfiability (SAT)-based attacks which use iterative SAT-solver calls to trim a key hypothesis space and recover a correct key. To thwart these attacks, several “point-function” techniques can be employed. The “point-function” techniques can, for example, employ functions with sparse truth-tables to create exponential minimum query counts for oracle-guided attacks. For example, “point-function” schemes can insert comparator-like functions into an integrated circuit to increase a minimum number of queries required for a successful attack. However, “point-function” techniques can be attacked with removal attacks (e.g., attacks that find these structures in the integrated circuit and remove the structures) and approximation attacks (e.g., attacks which disregard the point-function and recover the remainder of the integrated circuit for cases where the point-function techniques were mixed with other conventional techniques).

In general, locked integrated circuits can have query hardness present in point-function schemes with low-activity nets in which an attacker can recover the function if a large number of queries with little book-keeping are employed. Alternatively, a locked integrated circuit can have algebraic hardness in which very high-entropy/nonlinear/deep circuits do not need many queries, but the system of equations resulting from the few queries is difficult to solve.

In an aspect, an attack, unlike existing approximate attacks which either query blindly (e.g., approximate deobfuscation or AppSAT) or are tailored to specific point-function schemes (e.g., doubly differentiating input pattern or DDIP, SigSAT, or kDIP point-function scheme), can target any low-activity net (e.g., including low-activity nets inherent to the original integrated circuit) and can avoid adding numerous copies of useless query conditions to the SAT-solver for such nets. In another aspect, fanin of these low activity nodes can be fast-queried until rare and interesting queries are encountered, which are then added to the solver (e.g., Rare-and-Fast-Query or RFQ attack). This not only speeds up attacks on low-activity (e.g., point-function) locked circuits, but a mechanism can also be provided to detect such nodes in the circuit and separate the circuit into query hardness (e.g., EFS-like) and algebraic hardness (e.g., AFS-like). In another aspect, the RFQ attack can avoid exponential querying with early termination, and a defense technique can be employed to avoid these conditions and achieve always-exponential complexity for EFS schemes.

Embodiments herein address the aforementioned shortcomings and more by providing absorption-based logic locking for an integrated circuit. According to various embodiments, an exact-functional-secrecy (EFS) notion of security related to logic locking for an integrated circuit is employed. For example, various embodiments disclosed herein provide a novel EFS scheme that takes advantage of inherent comparator logic at the register-transfer (RT)-level for always-exponential-query EFS locking. In an aspect, the EFS notion of security can be related to a mathematical definition of security such that if a particular scheme achieves t-EFS, it is impossible for any oracle-guided or oracle-less attacker to recover the precise functionality of the circuit in anything less than t operations (e.g., where t is a number). As such, t-EFS security can be achieved.

According to various embodiments, the EFS locking technique can be realized via a control-heavy rs232 Verilog design, although it will be appreciated that the use of the rs232 Verilog design is a non-limiting example and other implementations are within the scope of the present disclosure. In embodiments, the EFS definition of security for logic locking can be satisfied in response to an attacker not being able to learn the functionality of the integrated circuit. Furthermore, the absorption-based logic locking technique disclosed herein is easier to achieve than approximate-functional-secrecy (AFS) which captures approximation-resiliency.

According to various embodiments, a locking approach targeting both EFS and AFS is provided based on finding already existing structures in an original integrated circuit and absorbing the already existing structures into the locking scheme rather than introducing additional resources. For EFS, comparator logic and/or constraints in the circuit can be identified. Furthermore, the comparator logic and/or constraints can be replaced with look-up-tables. For AFS, portions of logic can be identified and/or the portions of logic can be replaced with look-up-tables.

In various embodiments, by employing an absorption-based logic locking as disclosed herein, an integrated circuit can be protected from reverse engineering associated with untrusted foundries or end-users. In an embodiment, a logic locking technique can insert programmable logic into the integrated circuit design so that the integrated does not operate correctly without configuring the programmable logic with a secret configuration (e.g., a key). While existing locking techniques are additive with weak to no security guarantees, the absorption-based logic locking technique disclosed herein can be based on absorbing already existing comparator logic in the design into tamper-resistant look-up-tables. In various embodiments, higher level representations of the design (e.g., Register-Transfer-Level or RTL descriptions) can be employed. In various embodiments, design of a look-up-table (LUT) design can be configured such that it masquerades as being deeper and wider than it is functionally, increasing the search space for an attacker exponentially.

According to various embodiments, a deobfuscation process can be divided into deobfuscating high-activity nets and deobfuscating low-activity nets. The deobfuscating high-activity nets can contribute to AFS and can be handled by a few queries and satisfiability (SAT)-solving. The deobfuscating low-activity nets can search for rare queries which can be decoupled from the SAT-solver. In an embodiment, the deobfuscation process can be divided into deobfuscating high-activity nets and deobfuscating low-activity nets by an SAT-based attack. For example, the SAT-based attack can be a Rare-and-Fast-Query (RFQ) SAT attack that provides key-correctness for logic outside of low-activity cones and is not exclusive to a specific low-activity locking technique. According to various embodiments, the RFQ SAT attack can avoid exponential querying. According to various embodiments, an EFS logic locking technique can employ comparator logic at the Register Transfer Level (RTL) of control-oriented designs of an integrated circuit to, for example, achieve always-exponential EFS security.

According to various embodiments, circuit locking (cL) can be a combinational circuit locking scheme. For example, a combinational circuit locking scheme for a family of combinational circuits Cₒ is a probabilistic polynomial time (PPT) algorithm Lock^{Co} that takes security parameter λ and an original circuit cₒ∈Cₒ, and returns the locked combinational circuit cₑ and a correct key k*, with the following:
(l Added Key-Inputs) When cₒ: I→O where I=F₂ⁿ and O=F₂^{m}, then cₑ: I×K→O

where K=F₂^{l}.
(Correct Functionality under Correct Key) With ∀i∈I, cₑ(i, k*)=cₒ(i).
(Polynomial Overhead) With size(cₑ)≤poly(size(cₒ)) and depth(cₑ)≤poly(depth(cₒ)).

As such, locking can be directly modeled. Furthermore, in certain embodiments, locking can be associated with polynomial work camouflaging and/or split-manufacturing. In certain embodiments, subexponential SAT/BDD complexity and/or a priori information associated with the original integrated circuit can be encoded in Cₒ.

Given this definition, two notions of security focusing on hiding the functionality of cₒ rather than key-recovery (e.g., functional-security implies key-security) can be provided using OG/OL for oracle-guided/oracle-less attackers respectively and assuming (cₑ, k*)←Lock^{Co}(cₒ, λ):

In an aspect, the adversary A has cₑ and can make up to q chosen input queries to cₒ and wins by returning a circuit perfectly equivalent to cₒ. A cL scheme can be (t, q, σ)-EFS-OG secure, if the advantage of any A bounded by t operations is no more than σ better than adversary A′ that makes q queries and randomly guesses the remaining 2ⁿ−q entries of cₒ's truth table. (t, σ)-EFS-OL corresponds to a similar game except the adversary has no oracle of cₒ ((t, σ)-EFS-OL≡(t, 0, σ)-EFS-OG).

According to various embodiments, approximation-resiliency can be employed as security criteria. For example, AFS can be employed where the adversary A has cₑ, can make up to q chosen input queries to cₒ, and has to return an E-approximation¹ of cₒ. A cL scheme can be (t, q, ϵ, σ)-AFS-OG secure if the advantage of any A bounded by t operations is no more than σ better than the advantage of the adversary A′ that makes q queries to cₒ and randomly guesses the remaining 2ⁿ−q truth-table entries. For OL attackers, (t, f, σ)-AFS-OL≡(t, 0, ϵ, σ)-AFS-OG. With approximation-resiliency, an attacker is generally not able to learn the functionality of cₒ at any rate significantly faster than entry-by-entry querying the oracle of cₒ. In another example, best-possible approximate-functional-secrecy (BPAFS-OG) can be employed to measure advantage relative to an adversary A′ that is smart enough to use the best-learner of the function class Cₒ instead of randomly guessing the 2ⁿ−q remaining truth-table entries after q queries. This definition avoids the impossibility result by allowing the attacker to black-box-learn cₒ but not learn non-negligibly more than that from cₑ.

### A. EXEMPLARY SAT ATTACK

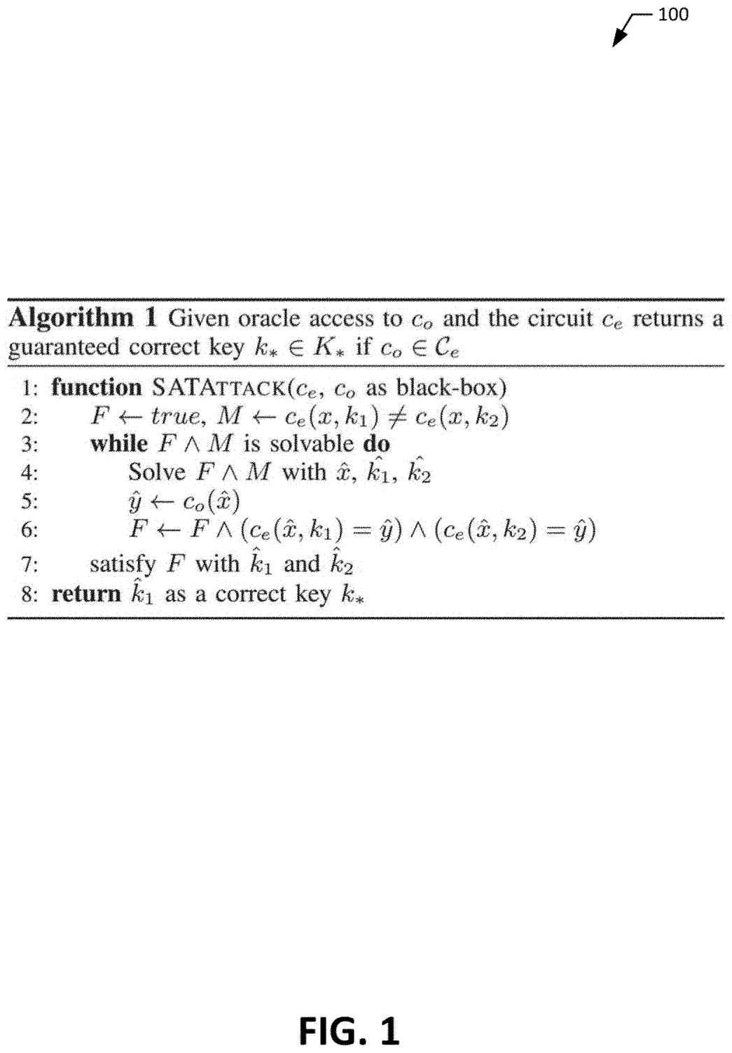

FIG. 1 illustrates an example algorithm 100 that provides a correct key given oracle access to cₒ and the circuit cₑ, according to various embodiments of the present disclosure. For example, the SAT attack illustrated in the algorithm 100 is a practical oracle-guided attack using modern SAT solvers that upon termination returns a guaranteed correct key. The algorithm 100 starts by building a mitter circuit M≡cₑ(x, k₁)≠cₑ(x, k₂). Satisfying the mitter circuit returns a discriminating input pattern (DIP) \hat{x} and two different keys \hat{k}₁ and \hat{k}₂. \hat{x} is queried on the oracle getting ŷ=cₒ(\hat{x}) and the resulting input-output observation pair is added to the mitter circuit formula. The process repeats until the mitter+IO-conditions is UNSAT, at which point the IO-conditions identify a correct key if co∈Cₑ, where Cₑ is the possible function space of the locked circuit; Cₑ={cₑ(x, k)|k∈K}.

According to various embodiments, AppSAT and DDIP are approximate SAT attacks. For example, AppSAT and DDIP attacks can exit early if a sufficiently good approximation is recovered. AppSAT uses random sampling to measure error and exits at a specific error threshold. DDIP modifies the mitter circuit condition to exit once no more discriminating input patterns that disqualify more than one key can be found.

### B. EXEMPLARY POINT-FUNCTION TECHNIQUES

A single-point-function P_{x*} on n-bit vectors or inputs can be a comparator function that outputs 1 when the input is equal to a specific pattern x* and 0 otherwise. A multi-point-function P_{{x*}} can output 1 if the input is equal to any member of a vector set x* and 0 otherwise. Such a point-function can provide low-activity output. For example, the probability of the output activating is m/2ⁿ for an m-point-functions. Various schemes can employ these functions for logic locking.

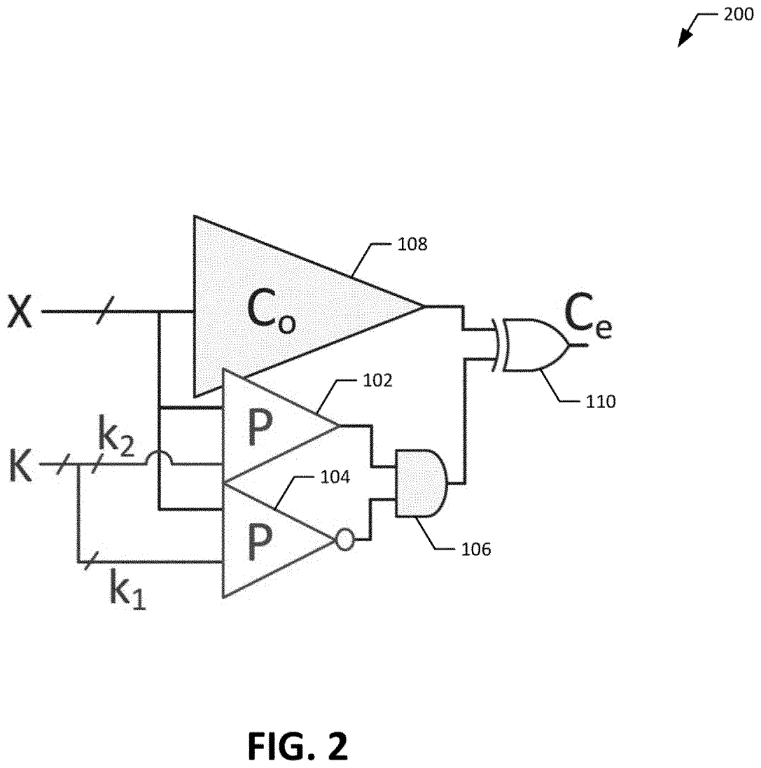

FIG. 2 illustrates an example system 200 associated with an AntiSAT point-function EFS scheme. In the system 200, a point-function 102 and a point function 104 that is complementary to the point-function 102 are provided to an AND logic gate 106. In an aspect, the point-function 102 and the point-function 104 can cancel each other out when the two key vectors k₁ and k₂ are equal. Output of a combinational circuit 108 and output of the AND logic gate 106 can be provided to an XOR logic gate 110. The XOR logic gate 110 can provide a locked circuit (Cₑ).

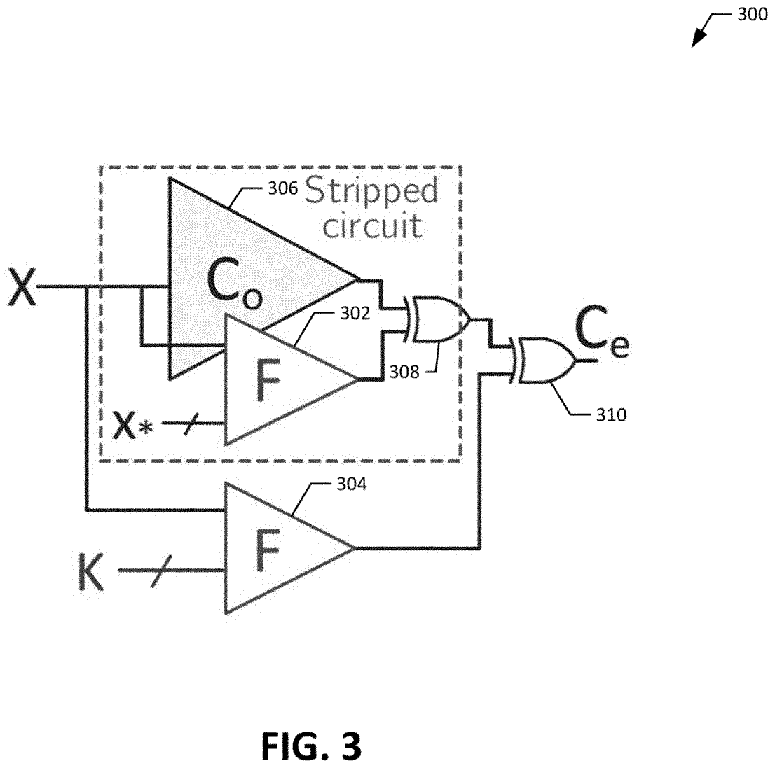

FIG. 3 illustrates an example system 300 associated with a stripped-functionality-logic-locking (SFLL) point-function EFS scheme. In the system 300, a low-activity function 302 (F(x, x*)) is employed to flip the functionality of the circuit. Afterwards, re-synthesis of the flipped logic 304 (F(x, k)) is used to restore the output yielding the correct key x*. In an example, an attacker that removes F(x, k) from the locked circuit (Cₑ) does not acquire the functionally-stripped circuit instead of the original integrated circuit. In an embodiment, output of a combinational circuit 306 and output of the low-activity function 302 can be provided to an XOR logic gate 308. Output of the XOR logic gate 308 and output of the flipped logic 304 can be provided to an XOR logic gate 310. The XOR logic gate 310 can provide a locked circuit (Cₑ).

### C. EXEMPLARY RARE-AND-FAST-QUERY (RFD) ATTACK

According to various embodiments, an RFD attack can be associated with deobfuscation hardness. For a locked circuit cₑ(x, k), key-recovery hardness can refer to an exemplary embodiment where a value of k* for given arbitrary queries to cₑ(x, k*) are difficult to obtain. In an aspect, key-recovery hardness can be associated with a one-way function related to cryptography. A one-way-function is a function ƒ (k) for which computing the function for a given input k* is easy. However, given the output of the function ƒ (k*), computing k* (e.g., reversing the function) is computationally intractable. According to various embodiments, a function ƒ can be designed such that given its output, guessing its input is difficult. According to various embodiments, one or more cryptographic hash-functions can be employed to create a deep and complex function based on multiple rounds of mixing/transforming input-bits. In an embodiment, a single bit flip in the input to the function ƒ can produce a large change in the output. Therefore, the function ƒ can be nonlinear and/or input sensitive. Furthermore, ƒ (xᵢ)=yᵢ can produce a high degree system of equations which can be difficult to solve if the function ƒ is wide/deep/nonlinear. In an aspect, such a hardness in reversing the function ƒ can be provided by the algebraic structure of ƒ and/or ultra-high entropy of the function ƒ.

A pseudo-random function (PRF) can be a different primitive than a one-way-function. For example, a PRF can be a function of two input vectors ƒ (x, k) for which a given random k*, ƒ (x, k*) is indistinguishable from a random function. This implies that finding k* is difficult given arbitrary chosen queries of the form ƒ (xᵢ, k*). Furthermore, learning k* given the ability to query does not employ exponential queries. For example, given a PRF ƒ (x, k): {0, 1}ⁿ×{0, 1}¹→{0, 1}, learning k* given adaptive queries on x of the form ƒ (xᵢ,k*) has query complexity O(l). For ƒ to be a PRF, the output of ƒ is indistinguishable from a randomly selected function from all possible functions from {0, 1}ⁿ to {0, 1}. If x is fixed in ƒ (x, k) to \hat{x} and the distribution ƒ (\hat{x}, k) over k∈{0, 1}^{l} is considered, this distribution is computationally indistinguishable from a random Boolean variable. Otherwise, ƒ (x, k) is distinguishable from a randomly selected function and not a PRF. As such, {ƒ (\hat{x}, k)|k∈{0, 1}^{l}} provides a statistically equal number of 0s and 1s. Hence, each query will disqualify half of the possible keys of ƒ allowing the correct key to be found with O(l) queries. Furthermore, learning hardness of PRFs result from algebraic complexity rather than query complexity.

According to various embodiments, input of a function can be hidden from output observations of the function by configuring the input to minimally affect the output. For example, a point function P_{k*}(x) can be configured to activate only when x is equal to k*. Therefore, if an attacker wants to find the value of k* from queries of P_{k*} (xᵢ), the attacker will have to perform in the worst case 2ⁿ−1 queries until a 1 is observed at the output at which point k* is revealed. This ultra-low-activity output is opposite to learning hardness of ultra-high-activity of PRFs. Therefore, essence of the function can be hidden. According to various embodiments, the point-function can hide a single point at which the point-function is activated. Hence, depending on the original integrated circuit, one or more features of the functionality of an original integrated circuit can be hidden.

According to various embodiments, low-activity signals can be determined. Given the dichotomy between point-function hardness and algebraic hardness, an RFD attack can separate these cases during deobfuscation. A property of point-function-driven query complexity is the highly skewed signal probability nets in such scenarios. Indeed, generally in practical circuit deobfuscation, skewed wires can create high query complexities and the baseline SAT attack is not geared towards such cases. When facing a query-heavy locked function cₑ(x, k) with an onset of size 1, the baseline SAT attack will iteratively come up with new DIPs on x, query them on the oracle, and then add two copies of cₑ(xᵢ, k) to the mitter circuit. This process continues until either all xᵢ patterns are queried and the output never activates, or the output activates on a few patterns and the attack will stop if the maximum point-capacity of cₑ(x, k) is reached. This results in a linear increase in the runtime and linear increase in memory of the attack. According to various embodiments, an RFD attack can rely on skewed wires as indicators of a query-heavy scenario signaling to the attack that the baseline SAT approach may be suspended for such wires.

For example, in a locked circuit cₑ(x, k) with query complexity q, there exists at least one wire whose function g(x_{g}, k_{g}) has a signal probability that is at least O(½q) distant from 0.5. According to various embodiments, an RFQ attack can identify low-activity wires and/or skewed wires. In certain embodiments, one or more heuristic approximation techniques can be employed to identify low-activity wires and/or skewed wires. For instance, in an embodiment, probability value propagation can be employed. With the probability value propagation, unconstrained input nets can be assigned probability 0.5 and the probability values for other nets are computed along a topological order by one or more probability propagation rules. For example, a probability propagation rule can compute the signal probability of an output of an AND logic gate as pₐ×p_{b}, where pₐ and p_{b} are the probability values of the input nets.

In certain embodiments, pattern simulation can be employed. For example, simulating approximately a thousand patterns on circuits with approximately hundreds of gates can achieve improved accuracy for signal probabilities. Furthermore, the number of patterns can be increased for more accuracy based on the size of the circuit. In an embodiment, simulation can be performed every j steps with a fixed number of keys extracted from the SAT solver consistent with input/output observations. As such, signal probability values can be based on a most recent hypothesis for the key. Furthermore, in certain embodiment, signal probability values can improve over the course of the attack.

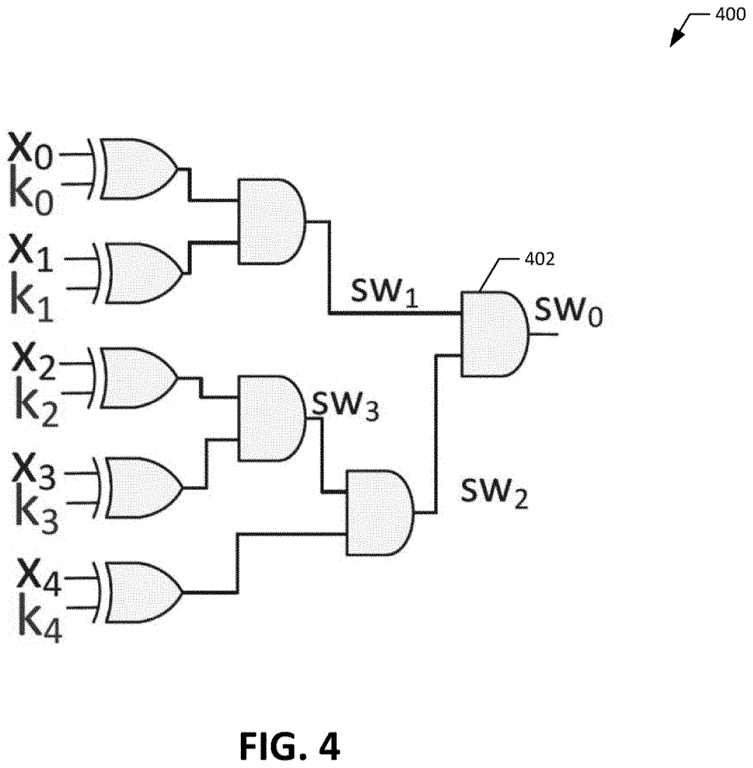

According to various embodiments, the RFQ attack can employ skewed functions (e.g., skewed “cones”) rather than single nets. FIG. 4 illustrates an example system 400 associated with an AND-tree cone. For example, the system 400 can include an AND-tree with progressively more skewed nets where sw₀ corresponds to a top of a skewed cone. In this point-function structure, internal nodes of the AND-tree can comprise skewed probabilities. Furthermore, skewedness of the probabilities can increase as the AND-tree is traversed closer to the tip of the AND-tree (e.g., as the AND-tree is traversed closer to the AND gate 402 at the tip of the AND-tree). According to various embodiments, in order to extract the tip of the skewed cone and after skewed nets are identified, a containment analysis can be performed to remove the skewed nets that are contained within the transitive-fanin of another skewed net (e.g., a possibly more skewed net).

According to various embodiments, outside-of-skewed cone querying can be performed. Once the skewed cones are detected, the RFQ attack can conditionally deobfuscate the remainder of the circuit. In an embodiment, given a set of skewed cones gᵢ, the RFQ attack can launch a SAT attack that aims to solve the keys that are not blocked behind the gᵢ with a guarantee on the correctness of the keys. Referring back to FIG. 2, the mitter circuit in the SAT attack can comprise two copies of cₑ. For example, the mitter circuit can include a first copy cₑ(x, k₁) and a second copy cₑ(x, k₂). During the attack, the SAT solver can configure the outputs of these two circuits to differ by keeping x shared among the circuits. Furthermore, the SAT solver can determine two different keys \hat{k}₁ and \hat{k}₂ for which the difference between the two keys propagates to a difference at the output. According to various embodiments, the outside-of-cone querying can tie a single skewed cone gᵢ in cₑ(x, k₁) to a corresponding net in cₑ(x, k₂). Additionally, the SAT solver can determine \hat{x}, \hat{k}₁ and \hat{k}₂ for which gᵢ(\hat{x}, \hat{k}₁)=gᵢ(\hat{x}, \hat{k}₂). For example, the skewed cone is not the source of difference in the mitter circuit. By keeping the skewed cones invariant, it can be determined what input pattern assists with learning new information about key decisions that are not related to the skewed cone gᵢ. Once the DIP mining and IO-constraint addition concludes with an UNSAT result, a guarantee that cₑ(x, k₁) and cₑ(x, k₂) are equivalent can be obtained. For example, after determining that cₑ(x, k₁) and cₑ(x, k₂) are equivalent, the unknown in the deobfuscation problem is merely the precise functionality of gᵢ.

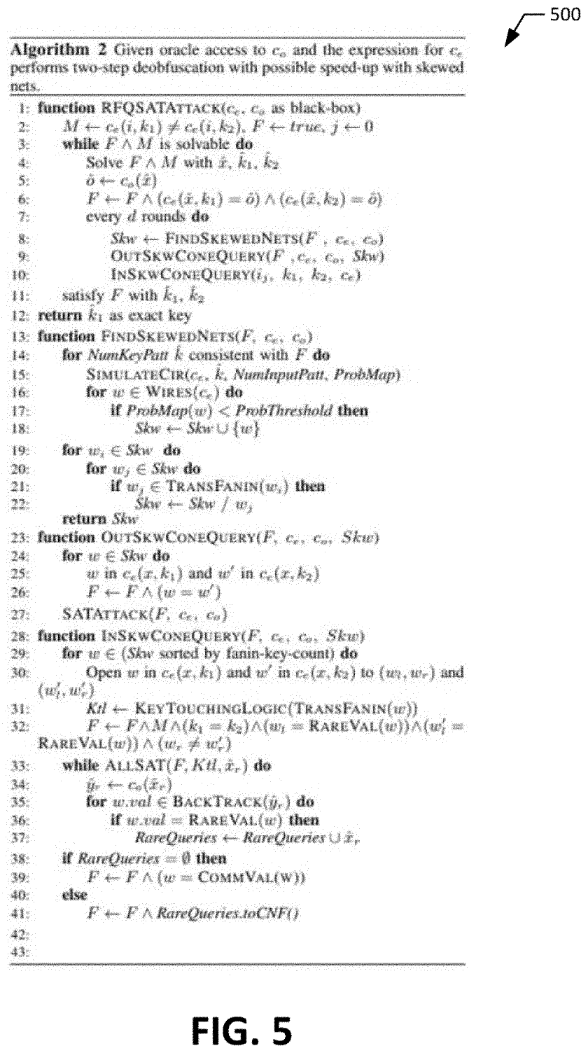

FIG. 5 illustrates an example algorithm 500 related to outside-of-skewed-cone querying, according to various embodiments of the present disclosure. For example, with the algorithm 500, the outside-of-skewed-cone querying is provided in the OUTSKWCONEQUERY routine (see, e.g., line 23) of the example algorithm 500.

According to various embodiments, EFS-OG security can be employed. Since the advent of EFS schemes such as Anti SAT, SARLock, SFLL, and the like, there have been numerous proposed so-called “removal” attacks. The idea in these attacks is that since point-functions schemes insert tree-like structures in the circuit, the tree-like structures can be identified and removed from a locked integrated circuit to obtain an original integrated circuit. The SPS attack, the wire-disagreement analysis of AppSAT, and the RFQ attack can detect low-activity nodes. For point-function schemes, low-activity nodes are typically the output of the inserted point-function structure which can be employed for a removal attack. However, security starts with the locking being performed on a family of original circuits Cₒ. In an aspect, the locking being performed can be employed to determine the security of a given scheme. For instance, impossibility results of AFS-OG apply only to certain circuit families which is encoded in Cₒ. In another example, the success and validity of removal attacks for EFS-OG relies on the family Cₒ. Referring back to the AntiSAT locked circuit shown in FIG. 2, the inserted structure (e.g., the Anti SAT block) is XORed with a wire in the circuit. With the correct key, the Anti SAT block outputs 0 on all input patterns x and therefore does not affect the circuit. Hence an attacker that finds the tip of the AntiSAT block in the circuit can proceed with a removal and recovery of the original circuit cₒ uniquely. However, if Cₒ is not restricted in any way, then there exists numerous other c′ₒ E Cₒ which are not equivalent to cₒ but could have been locked with a non-Anti SAT locking algorithm to produce the same cₑ.

In an example, the AntiSAT block ant(x, k) can be the AND of two complementary blocks g(x, k1) and g(x, k2) where k1 and k2 are two equal-length subkeys. If k1=k2, then ant(x, k) is equal to 0. Otherwise, if the g functions are AND-trees (e.g., maximum-query-complexity), then ant(x,k) can correspond to a point-function that flips the output on x=k1. For example, g(x, k2) will be equal to 1, allowing the g(x, k1) point-function to propagate, except for x=k2 where it will turn 0 and block an already 0 g(x, k2). The advantage of the removal attacker is that 1) does not know the precise description of Lock, and 2) cₒ is only size/depth-limited by cₑ, in the EFS-OG game, against point-SFLL, AntiSAT, and SARLock is O(½^{l}), l being the width of the point-functions used. As such, if cₒ is only slightly size/depth-limited and the attacker does not precisely know the Lock algorithm that is used (e.g., the attacker may have a distribution on a family of Lock algorithms but it is in no way realistic to assume the attacker knows Lock precisely), then EFS-OG security can be achieved. For example, a single multi-point-function can be XORed with a net in the circuit (e.g., without removing anything from the circuit) to satisfy the formal EFS-OG definition with exponential security.

According to various embodiments, after a first phase of the RFQ attack, low-activity nets can be extracted and the integrated circuit can be correct for all patterns that do not disturb the rare nets. For example, for a point-function with size 30, where 230 is approximately one thousand mega-queries and a 1 megahertz (Mhz) clock frequency of a combinational circuit is employed, one mega-query can be performed every second and in a thousand seconds (e.g., 16 minutes) a point-function of size 230 can be learned. Compared to a baseline SAT attack which requires storing and then solving a SAT problem with 230 copies of the obfuscated circuit, cₑ can correspond to a Terabyte of data if each circuit copy takes up only a Kilobyte.

In addition to the performance gain of fast-querying, phase 2 of the RFQ attack which can be designed for efficient querying of skewed cones can provide an automatic generic early exit in certain embodiments. In an embodiment, the P(x, x*) net can be identified in the circuit and the DIP that is identified can correspond to x*. Furthermore, querying x* on the oracle can resolve the key. For example, by querying x*, it can be determined that P(x, k) was activated to correct the corrupted output. Furthermore, by determining that the capacity/onset-size of P(x, k) is 1, the attack can be concluded since there can be no other point for P(x, k) to activate.

In an embodiment, various functional analysis techniques can be employed to determine comparator logic and/or extract input patterns that activate the comparator logic. In another embodiment, inside-skewed-cone querying for the RFQ attack can receive a set of skewed wires Skw. For each wire w in Skw, a single skewed cone w=gw(x, k). In an aspect, the output of gw(x, k) can be efficiently learned. In another aspect, the output of gw(x, k) can be observed since gw(x, k) may be an internal net. According to various embodiments, this can be achieved in the RFQ attack by opening/breaking up w to wₗ and wᵣ. wᵣ (e.g., right-side has path to output) and the mitter correspondent in cₑ(x, k2), and configuring wᵣ′ rare to differ using an XOR clause. As such, a difference at w can be propagated to a difference at the output (e.g., output of the circuit can be sensitive to w). In an aspect, a fast-query wₗ (e.g., a portion of an opened wire) can include a cone to inputs and keys wₗ=gₗ(x, k). In another aspect, gₗ(x, k) can produce a rare value which can correspond to the opposite of the majority of the simulation patterns for net w. According to various embodiments, the rare value can be added to the solver. Furthermore, the overall mitter formula can be produce an input to activate the rare net and propagate a result to the output.

In various embodiments, the RFQ attack can perform a backtracking step which employs an AllSAT routine. The AllSAT routine can determine the possible values of g(xᵣ, k) under the current condition on k given an input pattern xᵣ that can rare-activate a skewed net and an observed output co (xᵣ). Furthermore, the AllSAT routine can return all possible rare-net values based on an observation yᵣ=g(xᵣ, k). If all the possible values for a given skewed cone g are rare-values, then the query xᵣ can be determined to have triggered the rare net and can be added to the SAT solver as a valuable IO-constraint. Observations that do not satisfy this can be discarded. Discarding of typical-valued queries after backtracking can, for example, increase speed of the RFQ attack.

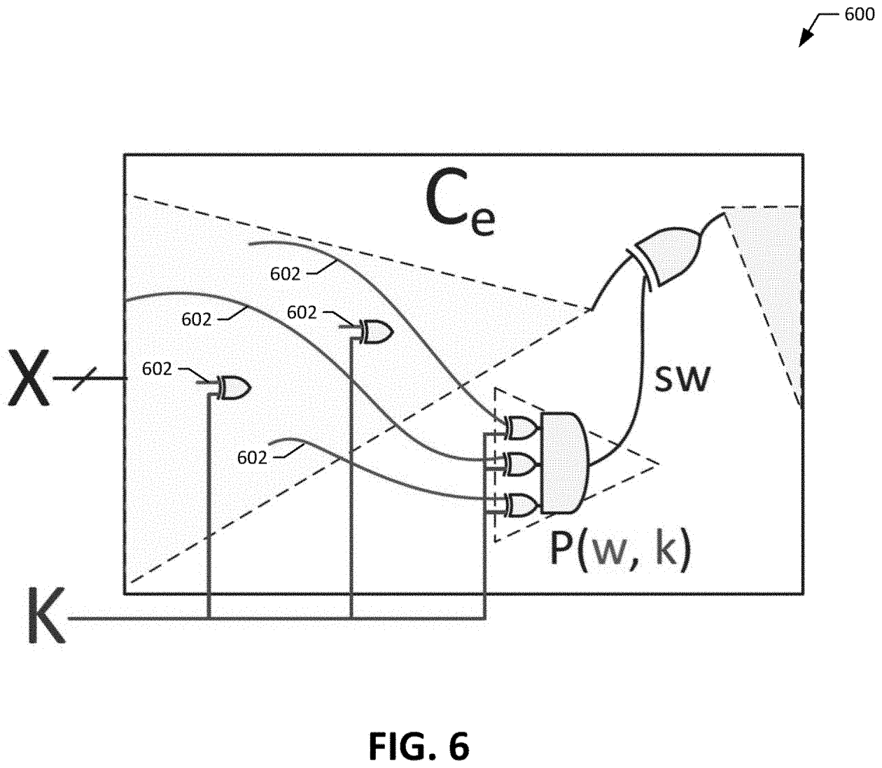

FIG. 6 illustrates a system 600 where skewed cones are inserted into a larger circuit. The wires 602 can be nets that first come into contact with the key. An AllSAT routine on wires 602 can capture all important queries in learning the skewed net sw.

Consider a keyed tree-based point-function T(x, k) inserted in the circuit. If this tree is attached to the primary inputs, by employing the skewed cone that results from this tree, g(x, k)=T(x, k) and the skewed cone exactly matches the tree. Hence, in order to query-learn g(x, k), all possible patterns of x can be scanned. However, assume the case where T is instead connected to a set of internal nodes in the circuit w={w₀, . . . , wₜ} as shown in FIG. 6. In such an embodiment, the fanin cone of T(w, k) includes all the fanins of each of the wᵢ nets. This results in an expansion of the domain of T from w to x={xⱼ|xⱼ is PI∈transfanin(wᵢ), wᵢ∈w}. Accordingly, by querying the entire domain of x, many more patterns than the domain of the inserted tree T will be queried. For each extra bit xⱼ that is added, this query range is doubled. Furthermore, it might become the case that even though T(w, k) is a point-function with small onset, g(x, k) will have an exponentially larger onset.

As such, in various embodiments, an SAT-based approach can be employed to query only necessary patterns. For example, all the internal wires in g(x, k) that are the first contact points between internal or primary-input wires can be identified. Furthermore, key-wires (e.g., red wires 602) can be identified. Therefore, by assigning all possible values to these first-key-touching wires, all possibilities of activating the rare net g(x, k) in the oracle circuit can be analyzed. In various embodiments, an AllSAT routine can additionally be employed to enumerate all of these patterns.

In various embodiments, the RFQ can employ a naive ban-clause approach for AllSAT based on adding a new clause to the solver on every new assignment discovery. As such, a non-constant memory footprint can be obtained. In various embodiments, a constant-space AllSAT routine can be additionally or alternatively employed to further improve runtime and memory of the RFQ. The INSKWCONEQUERY routine (see, e.g., line 28) of example algorithm 500 illustrates a procedure for learning skewed cones.

In various embodiments, the RFQ attack can be extended to sequential circuit deobfuscation. Sequential deobfuscation can be based on replacing the SAT calls in the SAT attack with model-checking (MC) queries. In various embodiment, Bounded-model-checking (BMC) can be employed to produce sequential attacks for shorter depth state graphs. For example, a sequential mitter can be employed and a BMC query up to round u can be employed to identify a discriminating input sequence (DIS). The DIS can be queried on a sequential oracle and can be added as a condition to the model-checking model or directly to the SAT solver that implements the BMC routine.

In various embodiments, the RFQ routine can be adapted to the sequential case since counter-logic and control finite-state-machines (FSM) can provide additional comparator logic as compared to arithmetic circuits. In an aspect, for a sequential RFQ attack, skewed signals can be detected similar to the combinational version. In various embodiments, the pattern simulation can be performed based on random sequences of randomly selected depth up to the current bound in the attack. In various embodiments, the skewed nets can be coupled in the unrolled mitter circuit for outside-cone querying to, for example, yield correct-under-skewed-assumption sequential keys. In various embodiments, a skewed cone g may include state-elements. As such, bounded unrolling can be employed to enumerate all sequences of x.

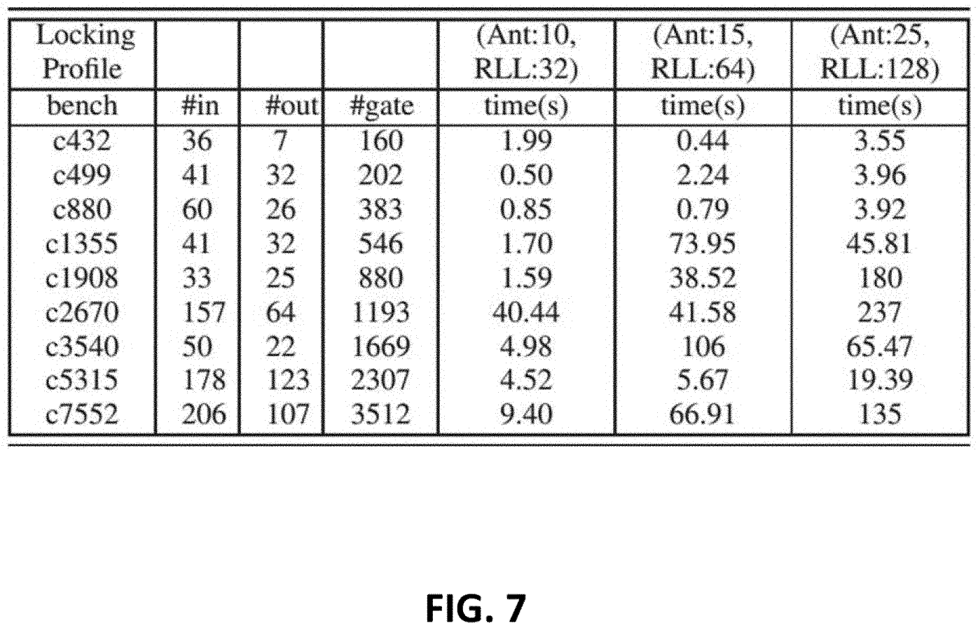

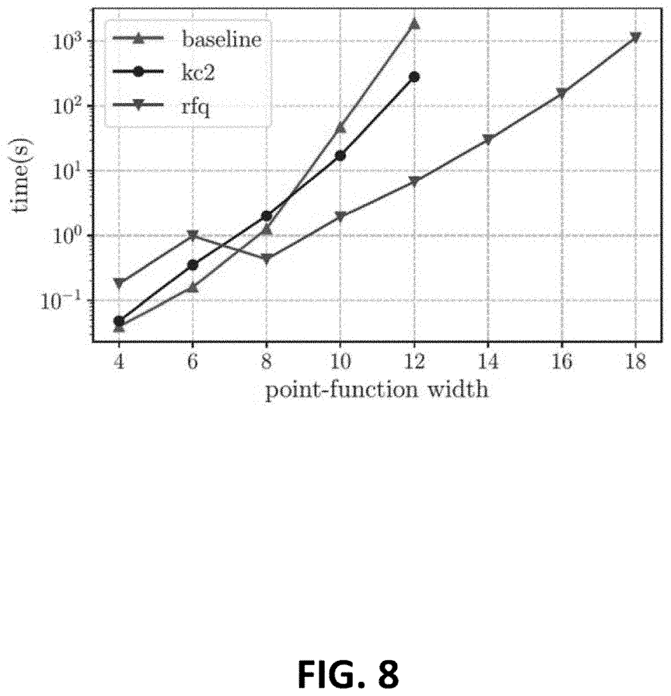

In various embodiments, an RFQ attack can be implemented on combinational circuits using an SAT solver. In various embodiments, with the absorption-based logic locking for an integrated circuit disclosed herein, success rate of skewed-net detection can be improved. In various embodiments, correctness of the keys outside of the skewed nets can be improved. The runtime of outside cone querying for example circuits locked with AntiSAT+RLL is shown in FIG. 7. Furthermore, FIG. 8 illustrates a comparison on the c432 benchmark circuit which shows orders of magnitude speedup compared to the baseline SAT attack and KC2 which performs simplification of key-conditions. In various embodiments, sorting of skewed nets according to the number of keys in a fanin (e.g., per line 29 of example algorithm 500) can facilitate improved detection of a corruption comparator. According to various embodiments, the RFQ attack can succeed in breaking specific EFS schemes without exponential querying.

### D. EXEMPLARY CIRCUIT IMPLEMENTATION

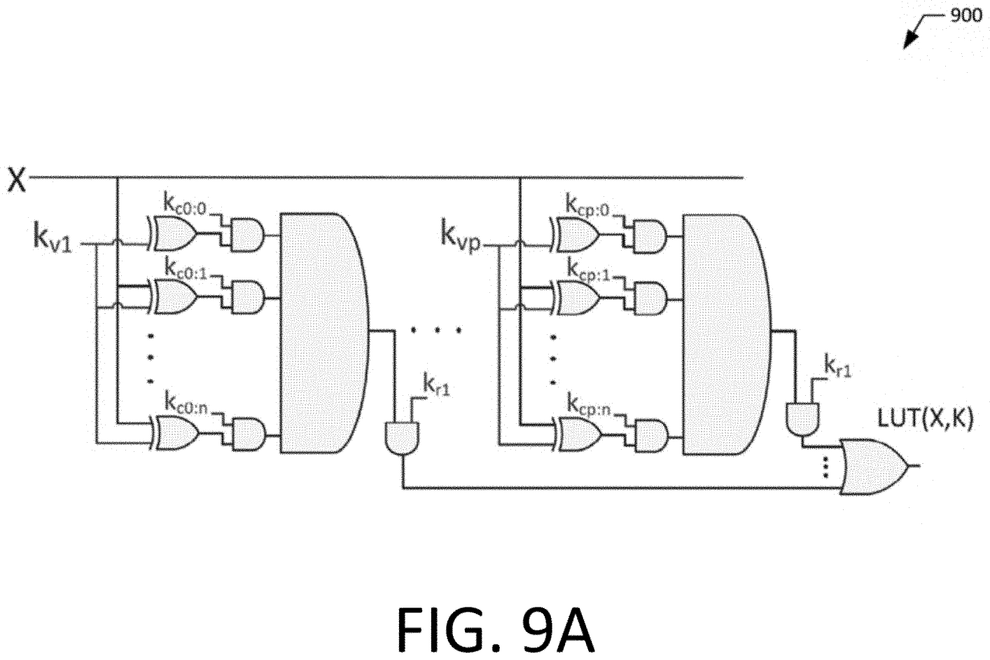

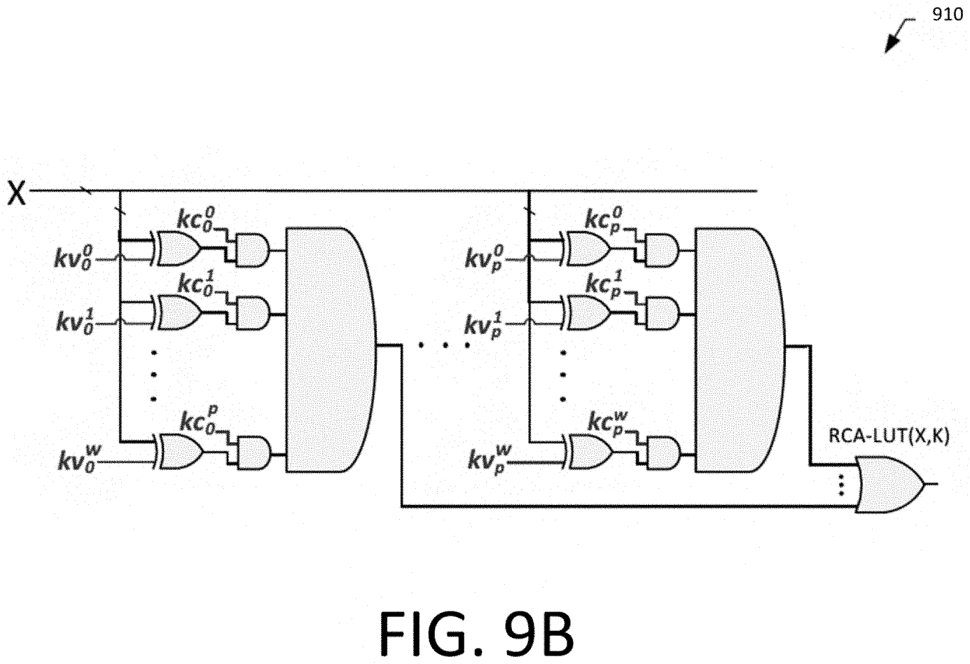

FIGS. 9A and 9B illustrate example combinational gate-level implementations of a row-column-activated look-up-table (RCA-LUT) circuit 900, 910. In an embodiment, the RCA-LUT circuit 900 can facilitate EFS-OG locking. For example, the RCA-LUT circuit 900, 910 can be a gate-level circuit that implements EFS-OG locking. For a p-entry LUT of width n, p different AND-trees of width n can be employed. In various embodiments, the RCA-LUT circuit 900, 910 can combine capacity-boosting and width-boosting with a look-up-table. In an aspect, the RCA-LUT circuit 900, 910 can provide boosting of a security level by an arbitrary exponential factor. Furthermore, with the RCA-LUT circuit 900, 910 with width w and capacity p, early-termination of attacks can be avoided and a 2^{w} security level can be provided.

Capacity-boosting can be employed to avoid early termination of an attack. For example, if a look-up-table needs to be used to restore r patterns, instead of using an r entry look-up-table, a p>r entry look-up-table can be employed. As such, even if an attacker encounters r corrected patterns, the attacker cannot be certain that an original circuit is recovered since, for example, there may be an additional p>r input patterns left that the look-up-table is activating on. In various embodiments, a look-up-table can be programmed to deactivate at least a portion of one or more rows of the look-up-table. In one example, such a look-up-table can be a row-activated look-up-table.

Width-boosting can also be employed to avoid early termination of an attack. For example, the row-activated look-up-table can store p programmable patterns. Each pattern can be an n-bit pattern (e.g., the width of the pattern). The security level of a scheme which uses patterns of width n can be, for example, 2ⁿ. With width-boosting instead of using a fixed look-up-table of width n, a wider look-up-table of width w>n can be employed. As such, security can be increased to 2^{w}. In various embodiments, the look-up-table can be configured for deactivating at least a portion of bits in the patterns. Such a look-up-table can be a column-activate look-up-table. In an embodiment, a user can program one or more bits in the patterns to deactivate (e.g., a value of the deactivated bits will not affect the output).

In various embodiments, output from each AND-tree can be ANDed with a key-bit which can configure the output of the AND-tree to 0 if the key-bit is set to 0. As such, activation of the rows can be provided based on the bit controls. Furthermore, the incoming input bits can be XORed with key-bits for each row. In various embodiments, the key-bits can correspond to the patterns stored in the rows of the LUT. Output of the XORs can be combined with another key-controlled AND gate to, for example, determine whether a particular bit is active on a particular row.

In an embodiment, the input vector X shown in FIGS. 9A and 9B can be XORed with p different key-vectors (kv₁ to kvₚ). Furthermore, the output of the XORs can be ANDed with enable bits in the form of p key-vectors (kc₀, kcₚ). The results can then be ORed together to create the output LUT(X, K) or RCA-LUT(X,K). In various embodiments, an enable bit can be provided for each bit of the table. As such, a row can be deactivated by disabling all columns (e.g., setting kcᵢ to all 0). In certain embodiments, the RCA-LUT circuit 900, 910 can be simplified by removing or sharing enable bits for various applications.

In various embodiments, a site-selection strategy can be employed. For example, where the RCA-LUTs are inserted and/or how the RCA-LUTs are inserted can be optimized. In various embodiments, an RCA-LUT can replace or “absorb” an existing comparator logic of the integrated circuit. As such, by starting from a higher-level description of a design of an integrated circuit (e.g., where a wide comparator logic can be detected), existing comparators can be absorbed into the RCA-LUT.

In various embodiments, Ternary-Content-Addressable-Memory (TCAM) arrays can be employed. The TCAM arrays can be transistor-level circuits that can perform value-lookup. In various embodiments, a structure of a CAM can comprise vertical and horizontal lines and a regular layout. Each cell in the CAM array can be a cell that can pull down a line that is shared across all cells in a row called the matchline (ML). In an aspect, the TCAM arrays can be sequential elements that employ a clock to pre-charge the ML line and read out the result using sense-amplifiers. In another aspect, the sequential CAMs can be employed to absorb sequential comparators (e.g., point-functions for which the result need not be ready until the next clock cycle).

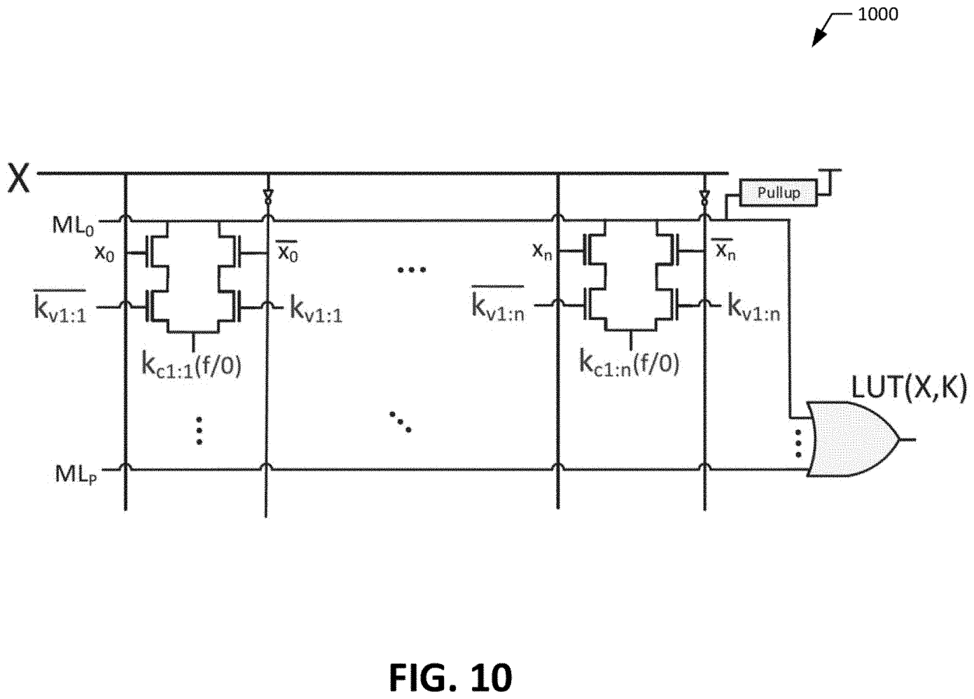

FIG. 10 illustrates a transistor-level CAM-based implementation of an RCA-LUT circuit 1000. The RCA-LUT circuit 1000 can be a combinational CAM that comprises a pull-up resistor to the ML line such that in an embodiment where no pull-down is asserted (e.g., a match case), the ML line can rise. In various embodiments, an inverter can be employed to amplify the ML line. In an aspect, the rise-time of the signal can be determined by an RC circuit formed by the pullup resistor and the pull-down network. In various embodiments, the RCA-LUT circuit 1000 can be associated with ML segmentation to facilitate increased speed of CAMs by breaking segmenting the ML into smaller pieces.

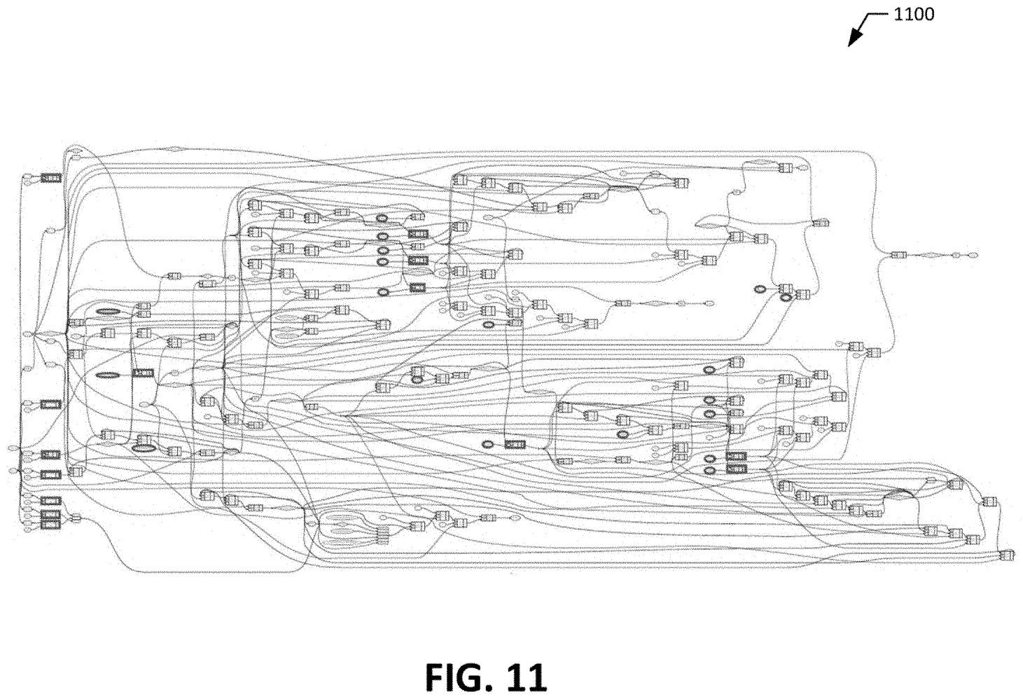

FIG. 11 illustrates an example RT-level flattened design 1100. The RT-level flattened design 1100 includes boxes that correspond to comparators that can be mapped to boosted RCA-LUTs. The RT-level flattened design 1100 also includes circles that are constants stored in a tamper-proof memory as secret keys for locking. In an embodiment, the RT-level flattened design 1100 can correspond to a JSON formatted representation of the design. In various embodiments, an intermediate stage can specify cells in the design and/or operators for the cells. In various embodiments, the RT-level flattened design 1100 can hide a control portion, a decoding portion, a finite state machine portion and/or a counter-logic portion of the integrated circuit.

In various embodiments, an obfuscation technique can begin at the RTL. The RTL can be employed, for example, to refer to representations of hardware designs that describe the word-level behavior of the integrated circuit hardware. For instance, hardware-description-languages (HDL) can be employed to describe integrated circuit hardware at the RT-level. In an aspect, the hardware programming languages can be parsed and “compiled” similar to a software program. A typical piece of RTL code can include numerous equality conditions. For example, “if (a==b) do . . . ”. In an embodiment, each equality condition in an RTL design can be a sparse function or a point-function (e.g., a function that activates on a small number of input patterns). Therefore, these point-functions can be absorbed to the RCA-LUT. If the comparison is done with a constant if (a==4′b0001), then the constant can become a programmable pattern within the RCA-LUT.

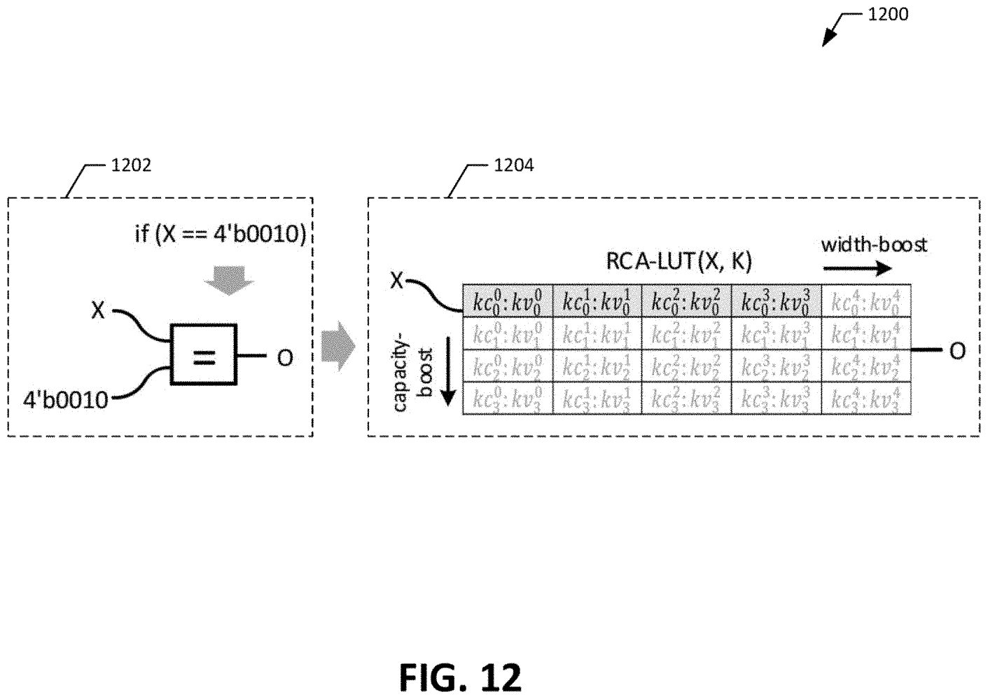

FIG. 12 illustrates an example system 1200 associated with a comparison statement and an RCA-LUT. For example, the system 1200 includes a comparison statement 1202 in RTL that is mapped to an RCA-LUT 1204. The RCA-LUT 1204 can be, for example, a width/capacity boosted RCA-LUT. In an aspect, the shaded cells shown in FIG. 12 (e.g., kc₀⁰:kv₀⁰, kc₀¹:kv₀¹, kc₀²:kv₀², kc₀³:kv₀³) can store a 4-bit constant while the extra cells can be deactivated by setting the kcᵢ^{j} bits to zero. As such, an attacker can be confused into thinking that wider and/or more numerous patterns are being employed.

In the embodiment illustrated in FIG. 12, width is boosted from 4 to 5 (e.g., width-boost) and capacity is boosted from 1 to 4 (e.g., capacity-boost). If the comparison is performed with another word (e.g., if (a==b)), the RCA-LUT can pass the input b XORed with a mask k into an entry of the LUT. Accordingly, an attacker does not know if a is being compared to b k (in which case finding k takes exponential work to recover precise functionality of the integrated circuit), or that a is being compared to another p entries in the RCA-LUT.

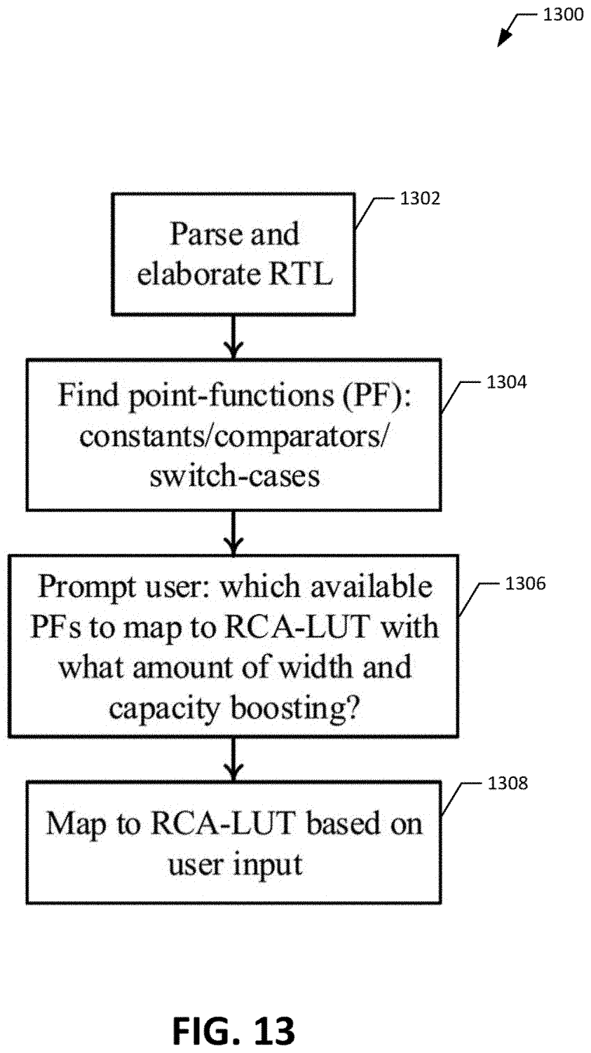

In various embodiments, an example method 1300 is employed to facilitate absorption-based logic locking for an integrated circuit. The example method 1300 shown in FIG. 13 illustrates an embodiment for locking flow in which a user is prompted for which point-functions to lock with the RCA-LUT. At block 1302, RTL is parsed and elaborated. At block 1304, point-functions (e.g., constants/comparators/switch-cases) are found or identified. At block 1306, a user is prompted to determine which available point-functions to map to RCA-LUT with what amount of width and capacity boosting. For width-boosting, in certain embodiments, extra wires can be selected from nearby locations in the integrated circuit. At block 1308, a mapping to RCA-LUT is provided based on user input.

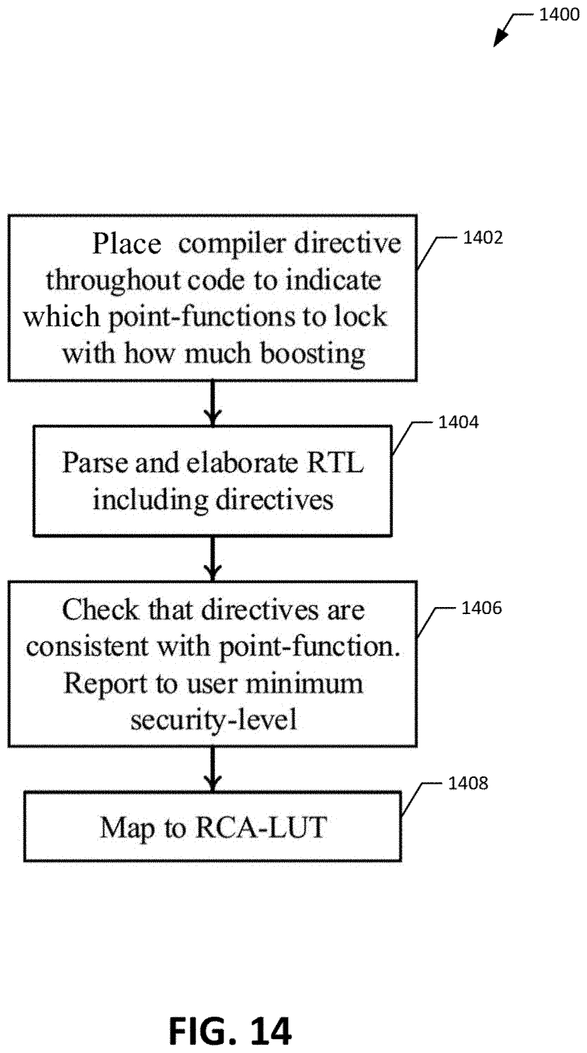

In various embodiments, an example method 1400 is employed to facilitate absorption-based logic locking for an integrated circuit. The example method 1400 shown in FIG. 14 illustrates an embodiment for locking flow in which a user can place directives in the RTL code to select which point-functions to lock with RCA-LUT. At block 1402, a compiler directive is placed (e.g., by a user) throughout code to indicate which point-functions to lock with how much boosting. For example, comment-like commands can be compiled by the RTL compiler. At block 1404, RTL including directives is parsed and elaborated. At block 1406, it is checked whether directives are consistent with the point function and a minimum security-level is reported to a user. At block 1408, a mapping to RCA-LUT is provided. In certain embodiments, which RCA-LUTs to map can be randomly determined based on one or more overhead constraints and/or one or more timing constraints.

### E. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for absorption-based logic locking, the method comprising:
receiving a point-function associated with Register Transfer Level (RTL) source code for an integrated circuit;
mapping data associated with the point-function to a first portion of a row-column-activated look-up-table (RCA-LUT);
deactivating a second portion of the RCA-LUT by setting bits of the second portion of the RCA-LUT to zero; and
replacing a portion of comparator logic for the integrated circuit with the RCA-LUT.

2. The method of claim 1, further comprising:
parsing the RTL source code to identify available point-functions.

3. The method of claim 2, wherein the point-function comprises a subset of the available point-functions.

4. The method of claim 2, wherein a point-function of the point-functions comprises one or more of a constant, a sequential element, a comparison statement, or a switch-case.

5. The method of claim 1, wherein the deactivating the second portion of the RCA-LUT comprises:
performing capacity-boosting associated with the RCA-LUT to increase a capacity of the RCA-LUT to a second size that is greater than a first size of the data associated with the comparison statement.

6. The method of claim 1, wherein the deactivating the second portion of the RCA-LUT comprises:
performing width-boosting associated with the RCA-LUT to increase a width of the RCA-LUT to a second bit pattern that is greater than a first bit pattern of the data associated with the comparison statement.

7. The method of claim 6, wherein width-boosting comprises selecting wires from nearby locations of the integrated circuit.

8. An apparatus for absorption-based logic locking, the apparatus comprising at least one processor and at least one non-transitory storage medium storing instructions that, with the at least one processor, configure the apparatus to:
receive a point-function associated with Register Transfer Level (RTL) source code for an integrated circuit;
map data associated with the point-function to a first portion of a row-column-activated look-up-table (RCA-LUT);
deactivate a second portion of the RCA-LUT by setting bits of the second portion of the RCA-LUT to zero; and
replace a portion of comparator logic for the integrated circuit with the RCA-LUT.

9. The apparatus of claim 8, wherein the at least one non-transitory storage medium stores instructions that, with the pat least one processor, further configure the apparatus to:
parse the RTL source code to identify available point-functions.

10. The apparatus of claim 9, wherein the point-function comprises a subset of the available point-functions.

11. The apparatus of claim 9, wherein a point-function of the point-functions comprises one or more of a constant, a sequential element, a comparison statement, or a switch-case.

12. The apparatus of claim 8, wherein the deactivating the second portion of the RCA-LUT comprises:
performing capacity-boosting associated with the RCA-LUT to increase a capacity of the RCA-LUT to a second size that is greater than a first size of the data associated with the comparison statement.

13. The apparatus of claim 8, wherein the deactivating the second portion of the RCA-LUT comprises:
performing width-boosting associated with the RCA-LUT to increase a width of the RCA-LUT to a second bit pattern that is greater than a first bit pattern of the data associated with the comparison statement.

14. The apparatus of claim 8, wherein width-boosting comprises selecting wires from nearby locations of the integrated circuit.

15. A system for absorption-based logic locking, the system comprising at least one server comprising at least one processor and at least one non-transitory storage medium storing instructions that, with the at least one processor, configure the system to:
receive a point-function associated with Register Transfer Level (RTL) source code for an integrated circuit;
map data associated with the point-function to a first portion of a row-column-activated look-up-table (RCA-LUT);
deactivate a second portion of the RCA-LUT by setting bits of the second portion of the RCA-LUT to zero; and
replace a portion of comparator logic for the integrated circuit with the RCA-LUT.

16. The system of claim 15, wherein the at least one non-transitory storage medium stores instructions that, with the pat least one processor, further configure the system to:
parse the RTL source code to identify available point-functions.

17. The system of claim 16, wherein the point-function comprises a subset of the available point-functions.

18. The system of claim 16, wherein a point-function of the point-functions comprises one or more of a constant, a sequential element, a comparison statement, or a switch-case.

19. The system of claim 15, wherein the deactivating the second portion of the RCA-LUT comprises:
performing capacity-boosting associated with the RCA-LUT to increase a capacity of the RCA-LUT to a second size that is greater than a first size of the data associated with the comparison statement.

20. The system of claim 15, wherein the deactivating the second portion of the RCA-LUT comprises:
performing width-boosting associated with the RCA-LUT to increase a width of the RCA-LUT to a second bit pattern that is greater than a first bit pattern of the data associated with the comparison statement.
